(19) United States
(12) Patent Application Publication
(10) Pub. No.: US 2025/0365155 A1
(43) Pub. Date: Nov. 27, 2025

(54) ELECTRONIC DEVICE AND METHOD FOR ACCELERATING BOOT PROCESS

(71) Applicant: Nuvoton Technology Corporation, Hsinchu Science Park (TW)

(72) Inventor: Wen-Hung HUANG, Taoyuan City (TW)

(21) Appl. No.: 19/199,553

(22) Filed: May 6, 2025

(30) Foreign Application Priority Data
May 22, 2024 (TW) 113118890

(51) Int. Cl. H04L 9/32

(52) U.S. Cl. CPC H04L 9/3236

(57) ABSTRACT

Embodiments of the present disclosure provide an electronic device. The electronic device includes a memory, a storage device, and a control device. The memory is configured to store a bootloader and an image. The storage device is powered by a battery dedicated to the storage device. The control device is configured to read and execute the bootloader to perform the following operations: determining whether the storage device stores a first hash value of the image; when the storage device stores the first hash value of the image, verifying the first hash value; and when the verification of the first hash value is successful, executing a firmware in the image.

### CROSS REFERENCE TO RELATED APPLICATIONS

This application claims priority of Taiwan Patent Application No. 113118890, filed on May 22, 2024, the entirety of which is incorporated by reference herein.

### BACKGROUND OF THE INVENTION

### Field of the Invention

The present invention relates to boot process, and, in particular, it relates to method for accelerating the boot process and the apparatus configured to perform the method.

### Description of the Related Art

After an electronic device is powered on, the bootloader is configured to verify the firmware that is to be performed. In the verification process, the bootloader checks the identity and integrity of the firmware to ensure that the firmware is secure. Performing the verification process can protect the electronic device, so it is a necessary process. However, performing a complete verification process takes a lot of time. Thus, a method for accelerating the boot process is required.

### BRIEF SUMMARY OF THE INVENTION

Embodiments of the present disclosure provide an electronic device. The electronic device comprises a memory, a storage device, and a control device. The memory is configured to store a bootloader and an image. The storage device is powered by a battery dedicated to the storage device. The control device is configured to read and execute the bootloader to perform the following operations: determining whether the storage device stores a first hash value of the image; when the storage device stores the first hash value of the image, verifying the first hash value; and when the verification of the first hash value is successful, executing a firmware in the image.

In some embodiments, the storage device is a register. In some embodiments, only the bootloader can read from or write to the storage device. In some embodiments, the control device is further configured to detect a tamper event. When a tamper event is detected, the control device is further configured to erase the storage device.

In some embodiments, when the verification of the first hash value is successful, the control device is further configured to execute the firmware without verifying a firmware signature in the image.

In some embodiments, the control device is further configured to perform the following operations. The control device inputs the firmware, the firmware public key, the firmware signature, and the firmware hash value of the firmware in the image into a secure hash algorithm to obtain a second hash value. The control device compares the first hash value to the second hash value. When the first hash value is equal to the second hash value, the control device determines that the verification of the first hash value was successful.

In some embodiments, when the storage device doesn't store the first hash value of the image, the control device is further configured to input the firmware, the firmware public key, the firmware signature, and the firmware hash value of the firmware in the image into a secure hash algorithm to obtain a second hash value. The control device is further configured to store the second hash value into the storage device.

Embodiments of the present disclosure provide a method for accelerating the boot process. The method is applicable to an electronic device comprising a memory, a control device, and a storage device. The memory is configured to store a bootloader and an image. The storage device is powered by a battery dedicated to the storage device. The control device is configured to read and execute the bootloader to perform the method. The method comprises: determining whether the storage device stores a first hash value of the image; when the storage device stores the first hash value of the image, verifying the first hash value; and when the verification of the first hash value is successful, executing a firmware in the image.

### BRIEF DESCRIPTION OF THE DRAWINGS

The present invention can be more fully understood by reading the subsequent detailed description and examples with references made to the accompanying drawings, wherein:

FIG. 1 is a block diagram of an electronic device in accordance to the embodiments of the present disclosure;

FIG. 2 is a flow diagram of the method for accelerating the boot process in accordance to the embodiments of the present disclosure; and

FIG. 3 is a flow diagram of the method for accelerating the boot process in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

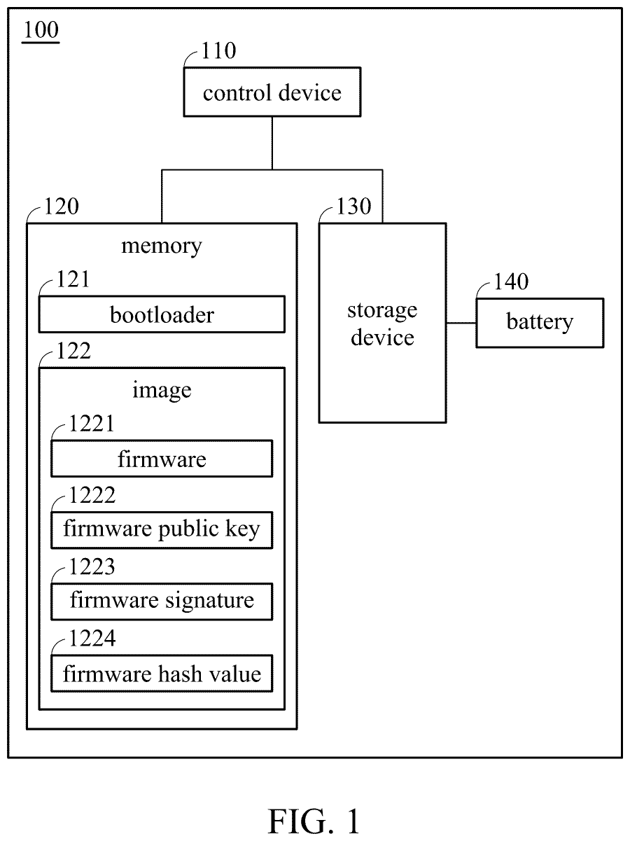

Refer to FIG. 1, FIG. 1 is a block diagram of an electronic device 100 in accordance to the embodiments of the present disclosure. The electronic device 100 comprises a control device 110, a memory 120, a storage device 130, and a battery 140. These components may exchange information with each other through one or more communication buffer. The electronic device 100 may be implemented in the form of one or more integrated circuit. For example, the electronic device 100 may be a desktop computer, a laptop computer, a tablet computer, a cellphone, or other similar devices.

The control device 110 provides the ability of calculation and data processing. The control device 110 is able to perform programs, software, firmware, modules, and operating systems. In some embodiments, the control device 110 may be implemented by multiple electronic components, including transistor, diodes, capacitors, resistors, or inductors. These electronic components are configured to implement specific purposes of the embodiments of the present disclosure. For example, the control device 110 may comprise general-purpose processor, specific-purpose processor, central processing unit, instruction set processor, and/or microcontroller unit.

Memory 120 may comprise non-volatile memory, such as read-only memory and flash memory. Memory 120 may also comprise volatile memory, such as dynamic random access memory and static random access memory. Memory 120 stores a bootloader 121 and an image 122. In some embodiments, the bootloader 121 and the image 122 are stored in the non-volatile memory of the memory 120. The bootloader 121 can be read and performed by the control device 110. When the bootloader 121 is read and performed by the control device 110, the bootloader 121 causes the control device 110 to implement the methods described below and activate the electronic device 100. The image 122 comprises a firmware 1221, a firmware public key 1222, a firmware signature 1223, and a firmware hash value 1224. The firmware public key 1222 and the firmware signature 1223 correspond to the public key and the signature of the firmware 1221 respectively. In some embodiments, the firmware hash value 1224 is a hash value obtained via inputting the firmware 1221 into a secure hash algorithm (SHA).

The storage device 130 is configured to store data. In some embodiments, the storage device 130 is separated from and different from the memory 120. In some embodiments, the storage device 130 is powered by a battery 140 that is dedicated to the storage device 130. In other words, the battery 140 provides power only to the storage device 130. In some embodiments, other components of the electronic device 100 (e.g. the control device 100 and the memory 120) may be powered by other power supply. For example, other power supply may be external power supply (e.g. socket) or other batteries. Thus, the power source of the storage device 130 is different from other components in the electronic device 100. In some embodiments, the storage device 130 is powered only by the battery 140 and has no other power source. In some embodiments, the battery 140 keeps providing power to the storage device 130 after the electronic device 100 is powered off.

When the storage device 130 is powered-off, the data stored in the storage device 130 will lost. On the other hand, the data stored in the storage device 130 won't lost as long as the battery 140 provides power to the storage device 130. Thus, the data stored in the storage device 130 won't lost even the electronic device 100 is turned off or powered off. In some embodiments, only the bootloader 121 can read from or write to the storage device 130. For example, only the control device 110 can read from or write to the storage device 130 through performing the bootloader 121. In this way, the security and reliability of the electronic device 100 can be improved. In some embodiments, the storage device 130 is a register. Comparing to other storage devices, registers are faster to read, and there is no limit to the number of times the registers can be programmed and erased. In other embodiments, the storage device 130 may be implemented by other storage devices, such as random access memories.

Furthermore, the electronic device 100 may comprise other components which aren't shown in FIG. 1. For example, the electronic device 100 may further comprise a display, a touch screen, a user interface (such as keyboard and mouse), a wireless communication device, and a speaker.

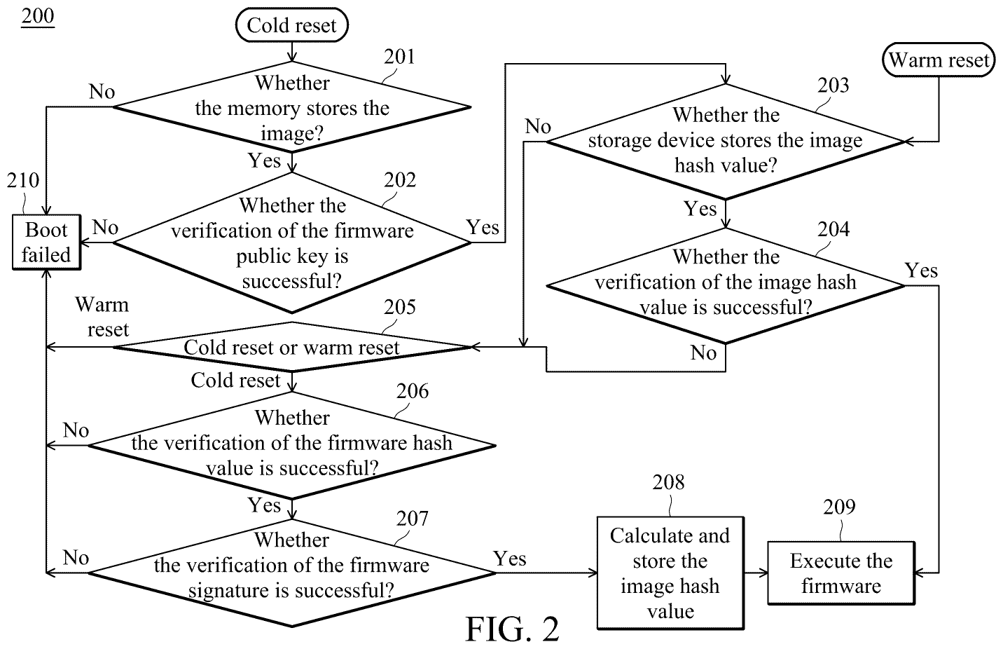

Refer to FIG. 2, FIG. 2 is a flow diagram of the method 200 for accelerating the boot process in accordance to the embodiments of the present disclosure. The method 200 can be applied to the electronic device 100 and be implemented in the electronic device 100. In some embodiments, the control device 110 read and execute the bootloader 121 to implement the method 200. Method 200 may be performed when the electronic device 100 is boot, reboot, or powered on. When the electronic device 100 performs a cold reset, the method 200 stars from operation 201. When the electronic device 100 performs a warm reset, the method 200 stars from operation 203. In this disclosure, the cold reset may refer to the boot method that the electronic device is powered on after being powered down. For example, the electronic device is first turned off and then turned on. The warm reset may refer to rebooting while the electronic device is powered on, such as performing a reboot using the software without turning off the power. In some embodiments, the warm reset is the watchdog time out.

In operation 201, the control device 110 determines whether the memory 120 stores the image 122. When the memory 120 doesn't store the image 122, method 200 proceeds to the operation 210. In operation 210, the control device 110 determines that the boot is failed. In some embodiments, the control device 110 displays an error message on the display or plays a warning sound using a speaker. When the memory 120 stores the image 122, the control device 110 reads the image 122, and the method 200 proceeds to the operation 202.

In operation 202, the control device 110 determines whether the image 122 stores the firmware public key 1222 and verifies the firmware public key 1222. When the image 122 doesn't store the firmware public key 1222 or the verification of the firmware public key 1222 is failed, the method 200 proceeds to operation 210. When the image 122 stores the firmware public key 1222 and the verification of the firmware public key 1222 is successful, the method 200 proceeds to operation 203. The control device 110 may verify the firmware public key 1222 using any known method.

In operation 203, the control device 110 determines whether the storage device 130 stores a hash value of the image 122 (also referred to as an image hash value). When the storage device 130 stores the hash value of the image 122, method 200 proceeds to operation 204. When the storage device 130 doesn't store the hash value of the image 122, method 200 proceeds to operation 205. In some embodiments, the image hash value is a hash value obtained via inputting the firmware 1221, the firmware public key 1222, the firmware signature 1223, and the firmware hash value 1224 into a SHA.

In operation 204, the control device 110 determine whether the verification of the image hash value stored in the storage device 130 is successful. When the verification of the image hash value is successful, method 200 proceeds to operation 209. When the verification of the image hash value is failed, method 200 proceeds to operation 205. In some embodiments, when the verification of the image hash value is failed, the control device 110 erases the image hash value stored in the storage device 130. In some embodiments, in operation 204, the control device 110 inputs the firmware 1221, the firmware public key 1222, the firmware signature 1223, and the firmware hash value 1224 into SHA to calculate a hash value (the second hash value). Then, the control device 110 determines whether the image hash value (the first hash value) is equal to the calculated hash value (the second hash value). When the image hash value stored in the storage device 130 is equal to the calculated hash value, the control device 110 determines that the verification of the image hash value stored in the storage device 130 is successful. When the image hash value stored in the storage device 130 is different from the calculated hash value, the control device 110 determines that the verification of the image hash value stored in the storage device 130 is failed.

In operation 205, the control device 110 determines the electronic device 100 is performing a cold reset or a warm reset. When the electronic device 100 is performing a cold reset, method 200 proceeds to operation 206. When the electronic device 100 is performing a warm reset, method 200 proceeds to operation 210.

In operation 206, the control device 110 determines whether the verification of the firmware hash value 1224 is successful. When the verification of the firmware hash value 1224 is successful, method 200 proceeds to operation 207. When the verification of the firmware hash value 1224 is failed, method 200 proceeds to operation 210. In some embodiments, in operation 206, the control device 110 inputs the firmware 1221 in the image 122 in the memory 120 into SHA to calculate a hash value. Then, the control device 110 determines whether the firmware hash value 1224 in the image 122 in the memory 120 is equal to the calculated hash value. When the firmware hash value 1224 is equal to the calculated hash value, the control device 110 determines that the verification of the firmware hash value 1224 is successful. When the firmware hash value 1224 is different from the calculated hash value, the control device 110 determines that the verification of the firmware hash value 1224 is failed.

In operation 207, the control device 110 determines whether the verification of the firmware signature 1223 is successful. When the verification of the firmware signature 1223 is successful, method 200 proceeds to operation 208. When the verification of the firmware signature 1223 is failed, method 200 proceeds to operation 210. The control device 110 may verify the firmware signature 1223 using any known method. For example, the control device 110 may verify the firmware signature 1223 using Elliptic Curve Digital Signature Algorithm (ECDA). In some embodiments, the control device 110 further verifies the integrity and the developer of the firmware 1221 using the firmware signature 1223. If the verification of the integrity and the developer of the firmware 1221 is successful, method 200 proceeds to operation 208. Otherwise, method 200 proceeds to operation 210.

In operation 208, the control device 110 calculates the hash value of the image 122 (the image hash value) and stores the calculated hash value of the image 122 in the storage device 130. In some embodiments, the control device 110 inputs the firmware 1221, the firmware public key 1222, the firmware signature 1223, and the firmware hash value 1224 in the image 122 into SHA to calculate the hash value. The control device 110 stores the calculated hash value into the storage device 130. Then, method 200 proceeds to operation 209. In the operation 209, the control device 110 executes the firmware 1221.

Thus, when the electronic device 100 is first powered-on (cold reset), the whole boot process is performed. In other words, the control device 110 performs operations 201, 202, 203, 206, 207, 208, 209. After identifying that the verifications of the firmware 1221, the firmware public key 1222, the firmware signature 1223, and the firmware hash value 1224 are successful, the control device 110 calculates the image hash value and stores the image hash value into the storage device 130. In the subsequent boot processes (the second boot and the boot after the second boot of the electronic device 110), the control device 100 only needs to verify the image hash value stored in the storage device 130. In other words, the control device 110 performs operations 201, 202, 203, 204, 209. Verifying the firmware signature (operation 207) takes a lot of time. Thus, the method described above can accelerate the boot process and shorten the time for booting via skipping the operation of verifying the firmware signature.

Because the storage device 130 can only read or write by the bootloader 121, the security and reliability of the image hash value can be guaranteed. Moreover, the when the control device 110 detects a tamper event, the control device 110 erases the image hash value in the storage device 130. Thus, the electronic device will perform the whole boot process to ensure the secure boot of the electronic device 100, after a tamper event happened.

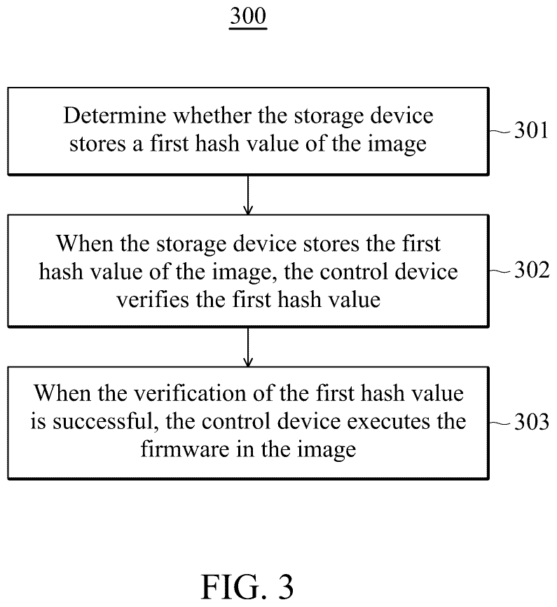

Refer to FIG. 3, FIG. 3 is a flow diagram of the method 300 for accelerating the boot process in accordance to the embodiments of the present disclosure. The method 300 can be applied to the electronic device 100 and be implemented in the electronic device 300. In some embodiments, the control device 110 read and execute the bootloader 121 to implement the method 300. Method 300 may be performed when the electronic device 100 is boot, reboot, or powered on.

In operation 301, the control device 110 determines whether the storage device 130 stores a first hash value of the image 122 (i.e. the image hash value). In operation 302, when the storage device 130 stores the first hash value of the image 122, the control device 110 verifies the first hash value. In operation 303, when the verification of the first hash value is successful, the control device 110 executes the firmware 1221 in the image 122.

Above embodiments are described or illustrated using a series of operations or events. However it should be understood that the order in which the operations or events are described should not be the limitation. For example, some operations may be happened in different order, or some operations or events described herein may be removed within reasonable limits. Moreover, one or more operations described herein may be performed in one or more separate operations and/or phases.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a memory, configured to store a bootloader and an image;
a storage device, powered by a battery dedicated to the storage device;
a control device, configured to read and execute the bootloader to perform operations of:
determining whether the storage device stores a first hash value of the image;
when the storage device stores the first hash value of the image, verifying the first hash value; and
when the verification of the first hash value is successful, executing a firmware in the image.

2. The electronic device as claimed in claim 1, wherein the storage device is a register.

3. The electronic device as claimed in claim 1, wherein only the bootloader can read from or write to the storage device.

4. The electronic device as claimed in claim 1, wherein the control device is further configured to perform operations of:
detecting a tamper event; and
when the tamper event is detected, erase the storage device.

5. The electronic device as claimed in claim 1, wherein the control device is further configured to perform operations of:
when the verification of the first hash value is successful, executing the firmware without verifying a firmware signature in the image.

6. The electronic device as claimed in claim 1, wherein the control device is further configured to perform operations of:
inputting the firmware, a firmware public key, a firmware signature, and a firmware hash value of the firmware in the image into a secure hash algorithm to obtain a second hash value;
comparing the first hash value and the second hash value; and
when the first hash value is equal to the second hash value, determining that the verification of the first hash value is successful.

7. The electronic device as claimed in claim 1, wherein the control device is further configured to perform operations of:
when the storage device doesn't store the first hash value of the image, inputting the firmware, a firmware public key, a firmware signature, and a firmware hash value of the firmware in the image into a secure hash algorithm to obtain a second hash value; and
storing the second hash value into the storage device.

8. A method for accelerating a boot process, applicable to an electronic device comprising a memory, a control device, and a storage device, wherein the memory is configured to store a bootloader and an image, the storage device is powered by a battery dedicated to the storage device, and the control device is configured to read and execute the bootloader to perform the method, wherein the method comprises:
determining whether the storage device stores a first hash value of the image;
when the storage device stores the first hash value of the image, verifying the first hash value; and
when the verification of the first hash value is successful, executing a firmware in the image.

9. The method as claimed in claim 8, wherein the storage device is a register.

10. The method as claimed in claim 8, wherein only the bootloader can read from or write to the storage device.
